(19) United States
(12) Patent Application Publication
(10) Pub. No.: US 2026/0302859 A1
(43) Pub. Date: Oct. 1, 2026

(54) COOLING A ROTOR OF AN AXIAL FLUX INDUCTION MACHINE

(71) Applicant: AURA SYSTEMS, INC., Lake Forest, CA (US)

(72) Inventors: Milad Darzi, Long Beach, CA (US); Ali Sarikhani, Mission Viejo, CA (US); Maryam Besharati-Givi, Lake Forest, CA (US); Harry Kurtzman, Lake Forest, CA (US)

(21) Appl. No.: 19/094,006

(22) Filed: Mar. 28, 2025

(51) Int. Cl. H02K 1/32; H02K 1/2793

(52) U.S. Cl. CPC H02K 1/32; H02K 1/2793

(57) ABSTRACT

An axial flux rotor assembly includes a shaft and an axial flux rotor. The shaft is disposed within and rotatably coupled with a housing of an axial flux induction machine. The shaft includes a fluid inlet and a fluid outlet. The axial flux rotor is coupled with the shaft and includes an inner cavity fluidly coupled with the fluid inlet of the shaft. The inner cavity includes multiple internal fluid conduits extending radially with respect to the shaft. The axial flux rotor defines a cooling fluid pathway extending (i) from the shaft to a first section of the internal fluid conduits, (ii) from the first section to a second section of the internal fluid conduits, and (iii) from the second section to the fluid outlet of the shaft to cool, as the cooling fluid flows along the cooling fluid pathway, the axial flux rotor.

### TECHNICAL FIELD

This disclosure relates to axial flux induction machines, and more particularly to rotors of axial flux induction machines.

### BACKGROUND

Electric motors and machines are widely used in various applications due to their robust design, reliability, and efficiency. Induction motors are a type of electric motors that operate on the principle of electromagnetic induction, where an alternating current (AC) in the stator windings generates a rotating magnetic field that induces a current in the rotor to rotate the rotor. Induction motors and machines can have a radial flux design or an axial flux design. Axial flux induction motors and machines have an axial flux design, in which the magnetic flux flows parallel to the axis of the shaft. This configuration features high power density and efficiency, making axial flux induction machines a good fit for applications where space and weight are critical. Improvements to axial flux induction machines are sought.

### SUMMARY

Implementations of the present disclosure include an axial flux rotor assembly that includes a shaft and an axial flux rotor. The shaft is disposed within and rotatably coupled with a housing of an axial flux induction machine. The shaft includes a first fluid inlet, a second fluid inlet, and a fluid outlet. The first and second fluid inlets are fluidly coupled with and configured to receive a cooling fluid from a pump. The axial flux rotor is attached with and rotates with the shaft. The axial flux rotor includes an inner cavity fluidly coupled with and configured to receive the cooling fluid from the first and second fluid inlets of the shaft. The inner cavity includes an inner channel, an outer channel, and multiple internal fluid conduits. The inner channel includes a first channel portion fluidly coupled with the first fluid inlet and a second channel portion fluidly coupled with the second fluid inlet. The first and second channel portions are fluidly coupled with the fluid outlet of the shaft. The internal fluid conduits extend radially between and are fluidly coupled with the inner channel and the outer channel. The internal fluid conduits include first internal fluid conduits and second internal fluid conduits. The axial flux rotor defines cooling fluid pathways to allow a cooling fluid to cool the axial flux rotor. The cooling fluid pathways include a first cooling fluid pathway and a second cooling fluid pathway. The first cooling fluid pathway extends from the first fluid inlet to the first channel portion, from the first channel portion through the first internal fluid conduits to the outer channel, and from the outer channel to the fluid outlet via the first channel portion. The second cooling fluid pathway extends from the second fluid inlet to the second channel portion, from the second channel portion through the second internal fluid conduits to the outer channel, and from the outer channel to the fluid outlet via the second channel portion.

In some implementations, the rotor includes a first conductive body, a second conductive body, and a magnetic body disposed between the first conductive body and the second conductive body. The first and second conductive bodies include multiple of radial bars interlocked with radial liners of the magnetic body to allow an axial magnetic field from a stator of the axial flux induction motor to extend through and rotate the rotor.

In some implementations, the rotor includes a first conductive body, a second conductive body, and a magnetic body. The first conductive body includes a first inner ring, a first outer ring, and a first group of bars spaced by first gaps and extending radially between and attached to the first inner ring and first outer ring. The second conductive body includes a second inner ring, a second outer ring, and a second group of bars spaced by second gaps and extending radially between and attached to the second inner ring and second outer ring. The magnetic body is attached to the shaft and is disposed between and interlocked with the first conductive body and the second conductive body. The magnetic body includes an inner body and multiple radial liners extending from the inner body. Each is disposed within the first and second gaps to form, with the first and second conductive bodies, the multiple internal fluid conduits enclose axially between the first and second group of bars.

In some implementations, the first conductive body defines, with a first face of the inner body of the magnetic body, a first ingress conduit and a second ingress conduit, and the second conductive body defines, with a second face of the inner body opposite the first face, a third ingress conduit and a fourth ingress conduit. The first and second ingress conduits extend between and are fluidly coupled with the shaft and the inner channel, and the third and fourth ingress conduits extend between and are fluidly coupled with the shaft and the inner channel.

In some implementations, the first ingress conduit is fluidly coupled with the first inlet of the shaft and the second ingress conduit is fluidly coupled with the second fluid inlet of the shaft. The third ingress conduit is fluidly coupled with the first inlet of the shaft and the fourth ingress conduit is fluidly coupled with the second fluid inlet of the shaft. In some implementations, the inner channel includes a first inner annular channel and the axial flux rotor assembly further includes a second inner annular channel. The first inner annular channel is formed between the first conductive body and the first face of the inner body, The second inner annular channel is formed between the second conductive body and the second face of the inner body.

In some implementations, the first conductive body defines, with the first face of the inner body of the magnetic body, a first egress conduit and second egress conduit. The first and second egress conduits are fluidly coupled with and extending between the fluid outlet of the shaft and the first inner annular channel. The second conductive body defines, with the second face of the inner body of the magnetic body, a third egress conduit and a fourth egress conduit. The third and fourth egress conduits fluidly area coupled with and extend between the fluid outlet of the shaft and the second inner annular channel.

In some implementations, the second inner annular channel includes a third channel portion and a fourth channel portion. The first ingress conduit extends between and is fluidly coupled with the first fluid inlet of the shaft and the first channel portion. The second ingress conduit extends between and is fluidly coupled with the second fluid inlet of the shaft and the second channel portion. The third ingress conduit extends between and is fluidly coupled with the first fluid inlet of the shaft and the third channel portion, and the fourth ingress conduit extends between and is fluidly coupled with the second fluid inlet of the shaft and the fourth channel portion. In some implementations, the first channel portion spans half a circumference of the first inner annular channel. The second portion spans the other half of the circumference of the first inner annular channel. The third channel portion spans half a circumference of the second inner annular channel, and the fourth channel portion spans the other half of the circumference of the second inner annular channel.

In some implementations, the magnetic body is made of a ferromagnetic material and the first and second conductive bodies are made of a diamagnetic material. In some implementations, the magnetic body forms, with the first conductive body, a first side surface that faces an axial flux stator of the axial flux induction machine, and the magnetic body forms, with the second conductive body, a second side surface oppose and facing away from the first side surface. The first side surface and second side surface are electroplated to fluidly isolate the multiple fluid conduits from the axial flux stator. In some implementations, the first conductive body includes a first coupling inner body and the second conductive body includes a second coupling inner body. The first and second coupling inner bodies are attached to and sandwich the inner body of the magnetic body to attach the magnetic body to the first and second conductive bodies.

In some implementations, the shaft and axial flux rotor rotate together with respect to one or more axial flux stators disposed within the housing. In some implementations, the pump flows the cooling fluid into the first and second fluid inlets of the shaft and flows the cooling fluid out of the multiple fluid conduits through the fluid outlet of the shaft.

Implementations of the present disclosure also include an axial flux rotor assembly that includes a shaft and an axial flux rotor. The shaft is disposed within and rotatably coupled with a housing of an axial flux induction machine. The shaft includes at least one fluid inlet and a fluid outlet. The at least one fluid inlet receives a cooling fluid to cool the shaft. The axial flux rotor is attached with and rotates with the shaft. The axial flux rotor includes an inner cavity fluidly coupled with and arranged to receive the cooling fluid from the at least one fluid inlet of the shaft. The inner cavity includes multiple internal fluid conduits extending radially with respect to the shaft. The axial flux rotor defines a cooling fluid pathway extending from the at least one fluid inlet of the shaft to a first section of the multiple internal fluid conduits, from the first section of the multiple internal fluid conduits to a second section of the multiple internal fluid conduits, and from the second section of the multiple internal fluid conduits to the fluid outlet of the shaft to allow the cooling fluid to cool, as the cooling fluid flows along the cooling fluid pathway, the axial flux rotor.

In some implementations, the at least one fluid inlet of the shaft includes a first fluid inlet, second fluid inlet. The axial flux rotor further includes an inner channel and an outer channel. The inner channel includes a first channel portion fluidly coupled with the first fluid inlet of the shaft and a second channel portion fluidly coupled with the second fluid inlet of the shaft. The first and second channel portions are fluidly coupled with the fluid outlet of the shaft. The multiple internal fluid conduits extend radially between and are fluidly coupled with the inner channel and the outer annular channel. The cooling fluid pathway including a first cooling fluid pathway and the axial flux rotor assembly includes a second cooling fluid pathway. The first cooling fluid pathway extends from the first fluid inlet to the first channel portion, from the first channel portion through a first section of the multiple internal fluid conduits to the outer channel and back to the first channel portion, and from the first channel portion to the fluid outlet. The second cooling fluid pathway extends from the second fluid inlet to the second channel portion, from the second channel portion through a second section of the multiple internal fluid conduits to the outer channel and back to the second channel portion, and from the second channel portion to the fluid outlet to allow the cooling fluid to cool, as the cooling fluid flows along the first and second cooling fluid pathways, the axial flux rotor.

In some implementations, the rotor includes an inner body including a pilot notch arranged to receive and engage with a rib of the shaft to align, during assembly of the rotor with the shaft, ingress conduits and egress conduits of the rotor with the fluid inlet and fluid outlet of the shaft. The ingress conduits and egress conduits are fluidly coupled with and extending between the shaft and the multiple fluid conduits of the rotor.

In some implementations, the axial flux rotor assembly also includes a fluid pump coupled with the shaft and arranged to flow the cooling fluid into the first and second fluid inlets of the shaft and flow the cooling fluid out of the multiple fluid conduits through the fluid outlet of the shaft. In some implementations, the pump is a variable speed pump configured to change a flow rate of the cooling fluid as a function of a speed of the axial flux rotor. In some implementations, the shaft and axial flux rotor are arranged to rotate together with respect to one or more axial flux stators disposed within the housing.

Implementations of the present disclosure also include a method of cooling an axial flux rotor, the method includes directing a cooling fluid into two fluid inlets of a shaft of an axial flux induction motor. The axial flux induction motor includes a housing, a stator, and a rotor attached to the shaft. The shaft is rotatably coupled with the housing such that the rotor and shaft rotate together with respect to the stator and the housing. The shaft includes the two fluid inlets and a fluid outlet. The axial flux rotor includes an inner cavity fluidly coupled with the two fluid inlets and fluid outlet of the shaft. The inner cavity includes multiple internal fluid conduits extending radially with respect to the shaft. The method also includes directing the cooling fluid along a cooling fluid flow path of the axial flux rotor. The cooling fluid flow path extends from the two fluid inlets, through the multiple internal fluid conduits, and to the fluid outlet, allowing the cooling fluid to cool the axial flux rotor. The method also includes directing the cooling fluid out of the axial flux induction motor through the fluid outlet of the shaft.

In some implementations, directing the cooling fluid into the two fluid inlets includes directing, with a variable speed pump controlled as a function of sensor feedback, the flow of the cooling fluid, the sensor feedback including at least one of a rotational speed of the rotor or a temperature of the rotor.

Particular implementations of the subject matter described in this specification can be implemented so as to realize one or more of the following advantages. For example, the axial flux induction machine of the present disclosure is capable of highly efficient operation and achieves significantly greater torque forces compared to other comparably sized axial flux motors and generators. Moreover, the rotor of the axial flux induction machine of the present disclosure allows direct contact between the coolant and heat-generating bodies of the rotor, which enhances the cooling capacity of the machine. Additionally, the cooling circuit configuration within the confined rotor body can help achieve greater cooling performance by minimizing the hot spot temperature. Moreover, the cooling system of the rotor can help decrease or eliminate the pressure drop within the cooling channels, which can help reduce the pump size, thus saving resources. Additionally, the rotor cooling system can have a cooling fluid circulation flow path that helps achieve highly uniform temperature and oil flow distribution over the rotor body, improving the cooling performance of the rotor. These features can help increase heat removal from heat-generating bodies to maintain colder rotor operation, which can minimize the rotor power loss and enhance the performance of the axial flux induction machine. These features can help increase heat removal from heat-generating bodies to maintain colder rotor operation, which can minimize the rotor power loss and enhance the performance of the axial flux induction machine.

### BRIEF DESCRIPTION OF THE DRAWINGS

FIG. 1 is a perspective, exploded view of an example of an axial flux induction machine.

FIG. 2 is a side cross-sectional view of the example of the axial flux induction machine in FIG. 1.

FIG. 3 is a perspective view of the example of the axial flux induction machine in FIG. 1.

FIG. 4 is a perspective view of an example of a rotor assembly.

FIG. 5 is a perspective, exploded view of the example of the rotor assembly in FIG. 4.

FIG. 6 is a perspective, cutaway view of the example of the rotor assembly in FIG. 4, showing a cooling fluid cavity.

FIG. 7 is a front schematic view of the example of the rotor assembly in FIG. 4, showing a cooling fluid flow path.

FIG. 8 is a front perspective view of an example of the cooling fluid cavity of the example of the rotor assembly in FIG. 4.

FIG. 9 is a back perspective view of the example of the cooling fluid cavity of the example of the rotor assembly in FIG. 4.

FIG. 10 is a front perspective view of a section of the example of the cooling fluid cavity in FIG. 8.

FIG. 11 is a flow chart of an example of a method of cooling a rotor.

FIG. 12 is a schematic illustration of an example control system for an axial flux induction machine.

### DETAILED DESCRIPTION OF THE DISCLOSURE

Generally, axial flux induction motors have higher power density than radial flux motors. One reason for this is the larger surface area of the stator to rotor. For example, in axial flux machines, the conductors pass through stator slots that extend in the radial direction with respect to the axis of rotation, whereas in radial flux machines, the conductors pass through stator slots extending in the axial direction. This difference between conductor placement in the slots of axial flux machines can lead to a greater coil area as compared to radial flux machines. This allows axial flux machines to have higher power per unit volume. These advantages enable the design of small, high-power dense motors.

In some cases, as the current density of the axial flux induction machine increases, the cooling requirement of the axial flux induction machine increases. Thus, with an increased requirement for cooling, and since substantial heat is generated in the rotor, the design and arrangement of the rotor and its cooling system become very important to the performance of the machine.

Due to the nature of the Ohmic and eddy current loss in conductive and magnetic paths, the cooling of the rotor of high-power motors has been a challenge. The axial flux induction machine of the present disclosure has a rotor that facilitates coolant circulation within the body of the rotor while maintaining the rotor fluidly sealed. The rotor enables the liquid coolant to flow through gaps embedded between the conductive and magnetic solid bodies of the rotor. In some implementations, the rotor has a magnetic body and one or more conductive bodies inter-faced together to form a cooling cavity embedded within the bodies, which allows the rotor to be efficiently cooled, minimizing the rotor power loss and increasing the efficiency of the axial flux induction machine.

Rotor cooling has been utilized in some electric motors, but traditional rotor cooling methods mostly include (i) oil flowing through the shaft where there is no direct contact between the oil and rotor, which results in minimal heat removal, or (ii) sprayed oil over the external surface of the rotor, which not only provides insufficient cooling but also causes a non-uniform temperature distribution over the rotor. The rotor of the present disclosure allows direct rotor cooling, which increases the heat transfer and cooling capacity of the rotor. Direct oil cooling system is a method to enhance the heat removal from axial flux induction machines leading to higher efficiency and at the same time enhancing the life and reliability of the insulation system.

The cooling circuit has been designed to increase or maximize the heat removal from the rotor without significant pressure drop penalty and produce a uniform temperature distribution over the entire rotor. The unique cooling circuit design features two separate inlet ports to ensure that the oil flow follows the rotor rotation. For example, the strong centrifugal force caused by the high rotational speed (up to 20,000 rpm) can act against the oil flow direction if the cooling circuit is not properly designed. The cooling circuit of the present disclosure allows the cooling fluid to flow in and out of the rotor to effectively cool the rotor.

The cooling fluid enters the rotor axially, moves in the axial and circumferential direction within the solid body of the rotor, and exits in the axial direction. For example, the cool oil enters the rotor through the shaft and then the hot oil exits the rotor and flows back to the shaft. The proposed active direct cooling of the rotor through the embedded cooling circuit within the rotor body can help reduce the rotor temperature with minimal pressure loss and consequently increase the efficiency of the axial flux induction motor.

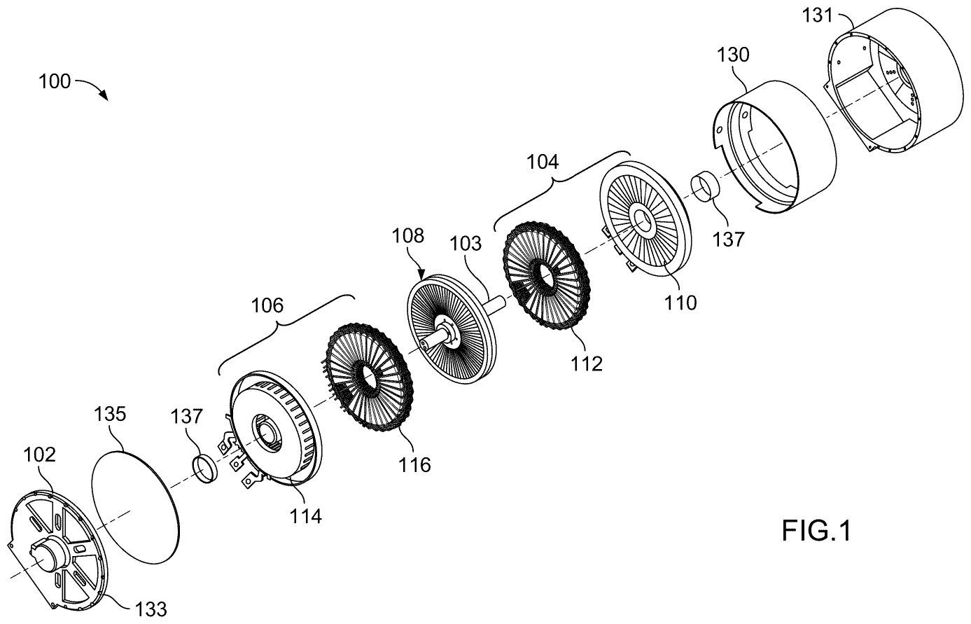

FIG. 1 is an exploded view of an example of an axial flux induction machine 100. The axial flux induction machine 100 can be, for example, an axial flux induction motor, generator, alternator, or starter. The axial flux induction machine 100 of FIG. 1 is illustrated as a three-phase axial flux induction motor. The axial flux induction machine 100 has a shaft 103, a rotor 108 (e.g., an axial flux rotor 108), two stators 104, 106 (e.g., axial flux stators 104, 106), and a housing 102. When assembled, the rotor 108, part of the shaft 103, and two stators 104, 106 re-side inside the housing 102. The housing 102 includes a housing body 131 and a cap 133. The axial flux induction machine 100 can also include other components such as a seal cylinder 130, rings 137 (e.g., bushings, slip rings, commutator rings, etc.), and seal ring 135 (e.g., an O-ring).

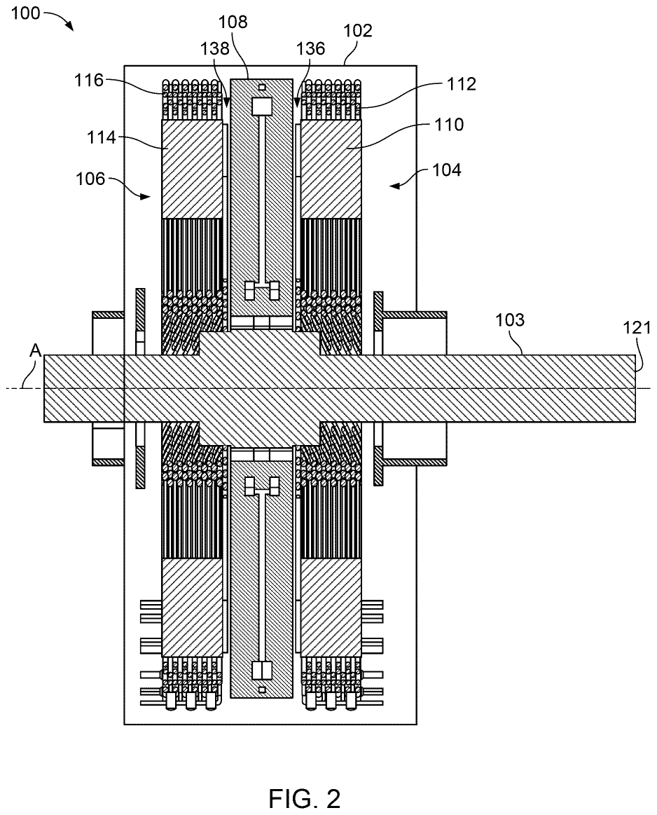

Referring also to FIG. 2, when assembled, the two stators 104, 106 are coupled (e.g., fixed) with the housing 102. The rotor 108 is mounted onto and coupled with the shaft 103. The rotor 108 resides in close proximity with and between the two stators 104, 106. The shaft 103 is rotatably attached (e.g., using bearings) with the housing 102 so that the shaft and the rotor 108 rotate together with respect to the housing 102 and the stators 104, 106.

Each stator 104, 106 includes a stator core 110, 114 and a coil winding assembly 112, 116 (e.g., stator field windings, coils, etc.). Each stator 104, 106 converts electrical energy to magnetic energy by providing a magnetic coupling between a magnetic flux of the stator and the rotor. As shown in FIG. 2, each stator 104, 106 faces each other and is sufficiently spaced away from the rotor 108 to define an air gap 136, 138 therebetween. As shown, the first stator 104 is spaced from the rotor 108 by a first air gap 1136 and the second stator 106 is spaced from the rotor 108 by a second air gap 138.

In some aspects, the stators 104, 106 are in a mirrored symmetrical relationship to each other. The rotor 108 rotates about an axis of rotation “A.” The coil winding assemblies 112, 116 are formed to fit into the available space provided by the housing 102. Each coil winding assembly 112, 116 can be made of copper or aluminum. In some implementations, each coil winding assembly 112, 116 includes a solid, pre-shaped, hair pinned round coil winding.

The symmetric mirrored placement of the stators 104, 106 causes the magnetic flux in the current carrying volume of the rotor 108 to be maintained perpendicular to the currents and parallel to the axis of rotation “A.” The positioning of the axial flux stators 104, 106 on both sides of the rotor 108 enhances the flux through the rotor 108 because less stator length is required for copper wire. In other words, the magnetic flux through the rotor 108 increases without decreasing the electrical conductivity through the rotor 108. In some implementations, the axial flux induction machine 100 has a different configuration. For example, to reduce the size of the housing, the housing 102 can house only one stator to rotate the rotor 108. Additionally, the machine 100 can include more than two stators, more than two rotors, etc.

The housing 102 provides structural support for the components inside the housing 102 to withstand the high levels of internal magnetic loads, electrical loads, and centrifugal force created during operation of the axial flux induction machine 100. Moreover, the shaft 103 holds the rotor 108 securely under both radial and axial loading, holding the rotor 108 precisely between the stators 104, 106 under all load conditions.

An end 121 of the shaft 103 extends out the front or back of the housing 102. For example, in some implementations, the shaft 103 is an output shaft with the end 121 of the shaft 103 connected, for example, to a wheel or an input shaft of a gearbox. In some implementations, the axial flux induction machine 100 is a generator, in which the shaft 103 is an input shaft that receives rotational energy (e.g., through a pulley, a gearbox, a crank, an engine, an actuator, etc.) to rotate the rotor 108 and generate electrical power. In such cases, the output of the axial flux induction machine 100 is electrical power (e.g., three-phase electrical power).

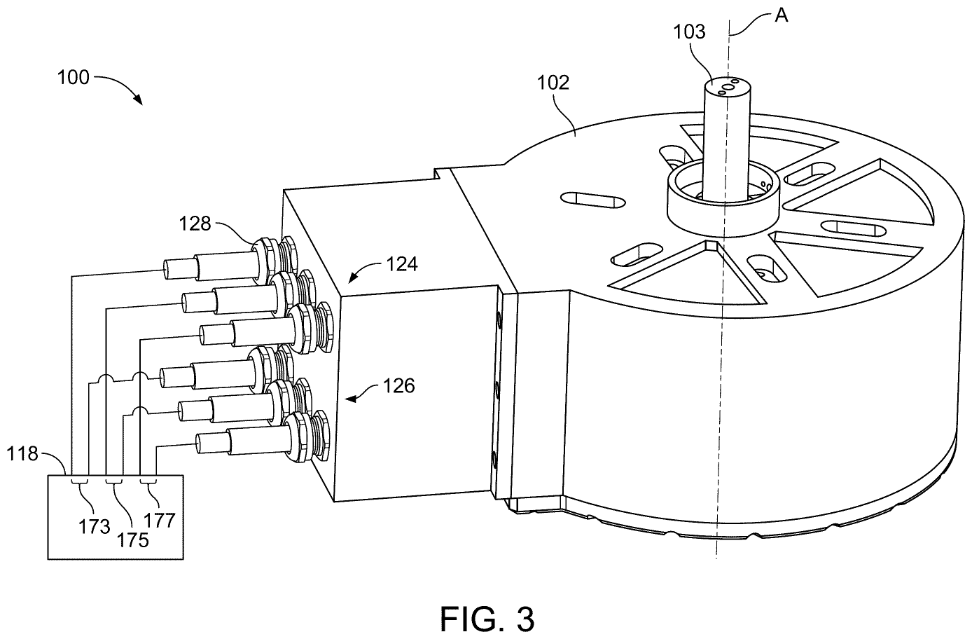

Referring also to FIG. 3, the axial flux induction machine 100 can also include an example control system 118 and two sets 124, 126 of terminals electrically coupled with the control system 118. Each set 124, 126 can be a set of three-phase terminals. In some implementations, each set 124, 126 has three terminals, one for each phase. In some implementations, the two sets 124, 126 of terminals are grouped in pairs 173, 175, 177 of terminals (and cables) each corresponding to one of the three phases. For example, the axial flux induction machine 100 has a pair 173 of first phase terminals and cables, a pair 175 of second phase terminals and cables, and a pair 177 of third phase terminals and cables. In some aspects, each of the cables extend from the control system 118 to the terminals. The two sets 124, 126 of terminals can extend through a side of the housing 102. In some implementations, the two sets 124, 126 of terminals are attached with the housing using electrical fittings 128.

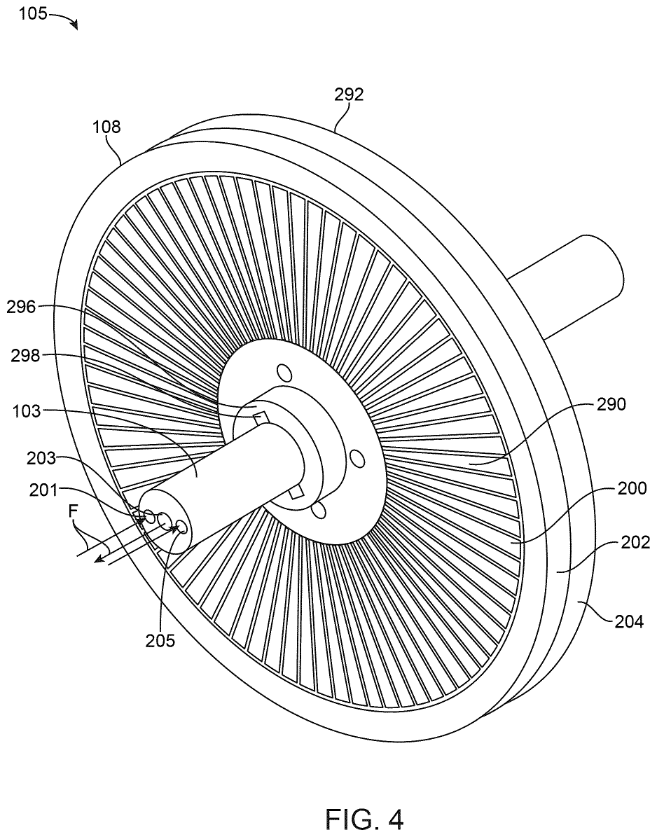

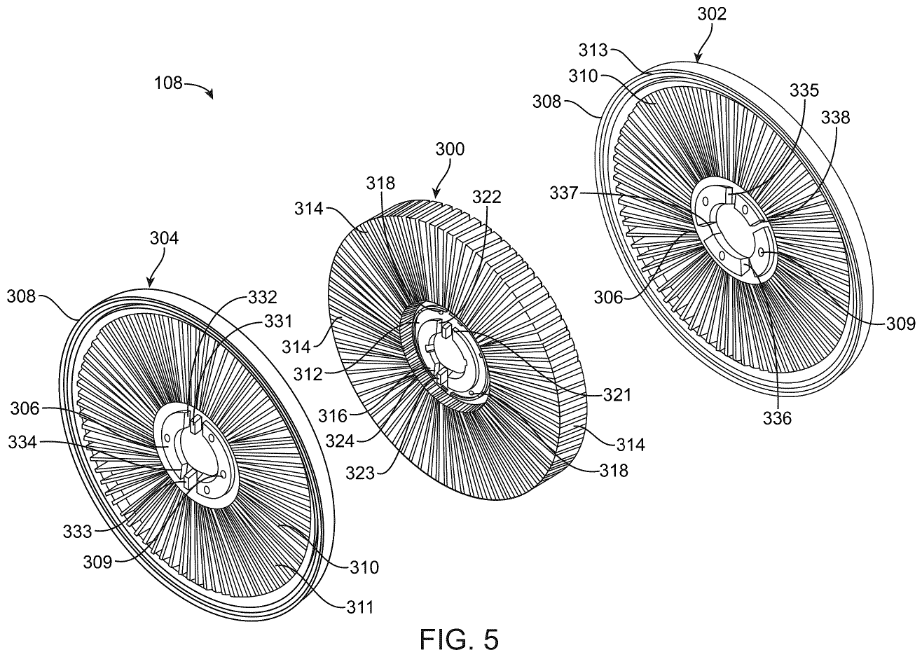

The control system 118 applies or transmits a power signal to the axial flux stators 104, 106 through the sets 124, 126 of terminals. The power signal can include three phases. For example, the control system 118 applies three-phase AC voltages to the coil winding assemblies 112, 116, applying a single-phase voltage to each terminal. As further described in detail below with respect to FIGS. 4 and 5, the rotor 108 has a magnetic body and conductive bodies (e.g., bodies that define conductive pathways), whereas the stators 104, 106 have electrical conductors. The magnetic body 300 is a body that can be magnetized (e.g., a metal with magnetic properties). The power supplied by the control system 118 sets up electric currents through the stators 104, 106 that create a series of magnetic poles which move in circular paths. This develops an axial magnetic field that extends across the air gaps 136, 138 and through the rotor 108 to rotate the rotor 108. In other words, each coil winding assembly 112, 116 allows an electric current to pass through the coil winding to generate an electromagnetic field in an axial direction (e.g., parallel to the axis of rotation “A” of the rotor 108) to rotate the rotor 108.

The control system 118 can be implemented as a high voltage power inverter module system. In some implementations, the inverter system can include one or more processors and a computer-readable medium storing instructions executable by the one or more processors to perform the operations described here. In some implementations, the controller or control system 118 is implemented as processing circuitry, firmware, software, high voltage switching devices or combinations of them.

FIG. 4 shows an example of an axial flux rotor assembly 105. The rotor assembly includes the rotor 108 (e.g., a rotor disk 108) and shaft 103. The rotor 108 can be coupled (e.g., fixed) with the shaft 103. For example, the rotor 108 is coupled with the shaft 103 so that the shaft 103 rotates when the rotor 108 rotates. In some implementations, the rotor 108 is bolted on, welded on, or even integrally formed with or part of the shaft 103. In some implementations, the rotor 108 can be removed from the shaft 103 to maintain or replace parts of the rotor assembly 105.

The rotor 108 includes a magnetic body 200 (e.g., a magnetic disk 200) and two conductive bodies 202, 204 (e.g., conductive disks 202, 204) interlocked with the magnetic body 200. In some implementations, the magnetic body 200 forms a magnetic path in the axial direction supported by magnetic material (e.g., magnetic steel material). In some implementations, the conductive bodies 202, 204 are nonmagnetic, and form an electrically conductive path supported by electrically conductive material (e.g., copper or aluminum) in the radial direction from the inner to the outer diameter of the rotor 108.

In some implementations, the magnetic body 200 is constructed primarily or entirely of ferromagnetic material and the two conductive bodies of 202, 204 are constructed of a diamagnetic and/or a conductive material. For example, the magnetic body 200 can be an integral (e.g., a one-piece) body constructed of magnetic steel and the conductive bodies of 202, 204 can be integral (e.g., one-piece) bodies made of copper or aluminum. Thus, the axial flux induction machine can be constructed without permanent magnets. These magnetic and conductive materials of the rotor 108 can, together, enhance the flux-carrying capacity of the rotor 108 and improve the electrical conductivity of the rotor 108 as compared to other axial flux machines, such as axial flux machines with permanent magnets.

The shaft 103 includes two fluid inlets 201, 205 and a fluid outlet 203. The two fluid inlets 201, 205 receive cooling fluid “F” (e.g., oil) that is directed from the shaft 103 to an inner cavity of the rotor 108. The inner cavity distributes the cooling fluid through an internal volume of the rotor 108 to allow the cooling fluid “F” to cool the rotor 108. The cooling fluid “F” exits the rotor 108 and is routed out of the shaft 103 through the fluid outlet 203.

In some aspects, the magnetic body 200 can form, with the first conductive body 202, a first side surface 290 that faces the first stator. The magnetic body 200 can also form, with the second conductive body 202, a second side surface 292 opposite the first surface 290 and that faces the second stator. For example, when assembled, the external surface of the magnetic body 200 can be flush or substantially flush with the external surfaces of the conductive bodies 202, 204. In some implementations, the first side surface 290 and second side surface 292 are electroplated to fluidly isolate the inner cavity of the rotor 108 from the stators.

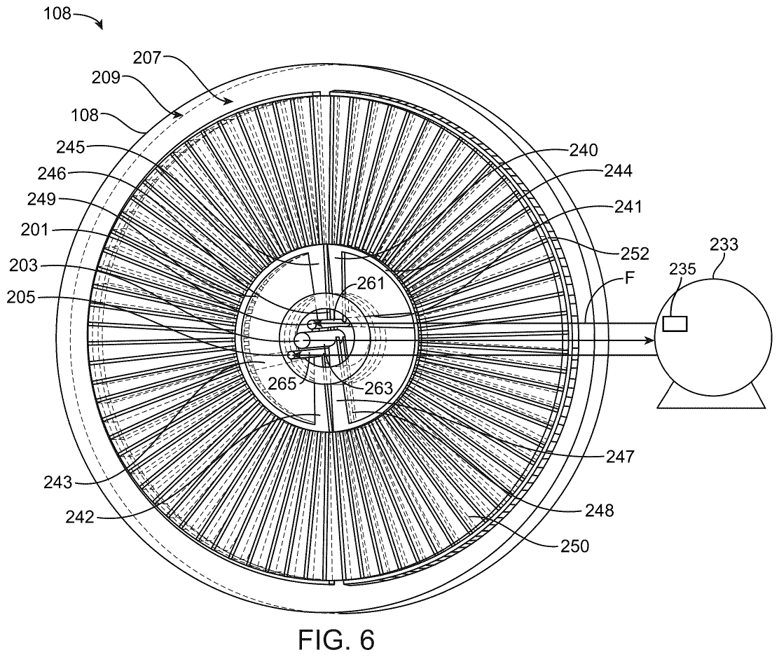

In some implementations, the magnetic body 200 has pilot notches 296 that receive and engage with ribs 298 of the shaft 103. As further described in detail below with respect to FIG. 6, the alignment enabled by the notches 296 and ribs 298 allows the fluid conduits 201, 203, 205 of the shaft 103 to be aligned with the internal inlet and outlet fluid conduits of the rotor 108.

FIG. 5 shows an exploded view of the rotor 108. The magnetic body 300 (e.g., a magnetic disk 300) is arranged to be interlocked with the two conductive bodies 302, 304 (e.g., conductive disks 302, 304) from both sides of the magnetic body 300. To form the rotor 108, the two conductive bodies 302, 304 are pressed against and locked within both sides of the magnetic body 300, forming an inner cavity defined between the two conductive bodies 302, 304. Thus, the magnetic body 300 resides between and is interlocked (in the axial and radial direction) with the first conductive body 302 and the second conductive body 302. The magnetic body 300 can be directly coupled with the shaft 103. Thus, the conductive bodies 302, 304 are coupled with the shaft 103 through the magnetic body 300.

Each conductive body 302 has an inner ring 306 (e.g., a coupling inner body 306), an outer ring 308, and multiple bars 310 (e.g., radial bars) spaced by gaps 311. The bars 320 extend radially between and are attached to the respective inner ring 306 and outer ring 308. In some implementations, the inner ring 306 connects all of the conductive paths in the inner diameter of the cylinder and the outer ring 308 connects all of the conductive paths in the outer diameter of the cylinder. In some implementations, the outer ring 308 has an annular groove 313 that receives an annular rib of the other conductive body 302 to form a tight fitting and a seal. In some implementations, the annular groove 313 is in both conductive bodies 302, 304 and a seal ring is disposed between the grooves to form a fluid seal.

The magnetic body 300 has an inner body 312 (e.g., a flange or plate 312) and multiple radial liners 314 extending from the inner body 312. When assembled, the radial liners 314 are each disposed within the gaps 311 of the two conductive bodies 302, 304. The bars 310 have a width such that, when assembled with the magnetic body 300, the bars 310 of the first conductive body 302 do not touch the bars 310 of the second conductive body 304 so as to form, an inner cavity defined between each pair of bars 310 facing each other. As further described in detail below with respect to FIG. 6, such inner cavity forms fluid conduits that extend from the inner body 312 of the magnetic body 312 to the outer rings 308 of the conductive bodies 302, 304.

The inner ring 306 of each conductive body 302, 304 can act as coupling flanges so that they sandwich the inner body 312 of the magnetic body 300 to attach the magnetic body 300 with the first and second conductive bodies 302, 304. The two conductive bodies 302, 304 can be attached to the magnetic body 300 with mechanical fasteners that extend through apertures 309, 318. The inner body 312 has a first face and a second face on the other side of the inner body 312 and facing away from the first face. The first face of the magnetic body faces an inner face of the first conductive body, and the second face of the magnetic body faces the inner face of the second conductive body.

The inner body 312 of the magnetic body 300 has a first notch 321, a second notch 322, a third notch 323, and fourth notch 324. The inner ring 306 of the second conductive body 304 has corresponding first, second, third, and fourth notches 331, 332, 333, 334. As further described in detail below with respect to FIG. 6, the notches of the magnetic body 300 extend from the shaft to the notches of the second conductive body 304 to form respective ingress and egress conduits. Similarly, the inner ring 306 of the first conductive body 302 has first, second, third, and fourth notches 335, 336, 337, 338 that correspond with notches (not shown) on the other side of the inner body 312 of the magnetic body 300 to form respective ingress and egress conduits.

FIG. 6 is a cutaway view of the rotor 108 showing the embedded cooling circuit 209 formed within the inner cavity 207 (e.g., embedded cavity) of the rotor 108. FIG. 6 also shows part of the fluid conduits 261, 263, 265 of the shaft (not shown). The inner cavity 207 includes four ingress conduits 240, 241, 242, 243, and four egress conduits 245, 246, 247, 248. The inner cavity 207 also includes two inner channels 244, 249, an outer channel 252, and multiple radial conduits 250 extending between and connected with the inner channels 244, 249, and the outer channel 252. The two inner channels 244, 249 are axially spaced by the magnetic body.

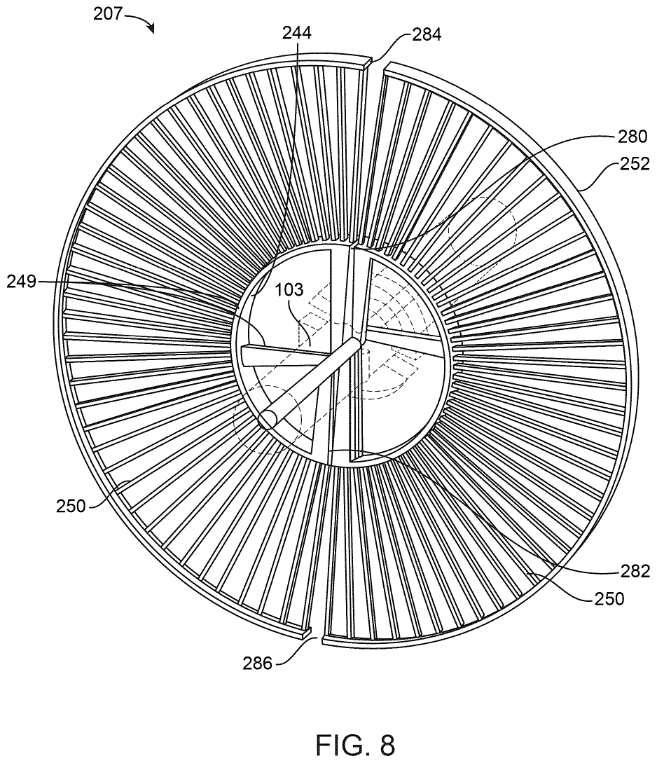

Referring also to FIG. 8, which shows the inner cavity 207, the two inner channels 244, 249 are not continuous, but are interrupted by small gaps 280, 282 defined between respective ingress and egress conduits. Similarly, the outer channel 252 is not continuous, but it is interrupted by small gaps 284, 286 that separate the inlet and outlet fluid pathways of the radial conduits 250.

Each radial conduit 350 is enclosed between two consecutive liners 314 (shown in FIG. 5) of the magnetic body 300 and two bars 310 (shown in FIG. 5) of the conductive bodies 302, 304 that are facing each other. Thus, each radial conduit 350 is axially bounded by the conductive bodies 302, 304, and circumferentially bounded by the magnetic body 300.

The four ingress conduits 240, 241, 242, 243, and four egress conduits 245, 246, 247, 248 are all defined between respective faces of the inner body 312 of the magnetic body, and between respective faces of the inner rings 206 of the conductive bodies 302, 304. Similarly, the first inner channel 244 (e.g., front inner channel 244) is formed between the first conductive body and the first face of the inner body 312, and the second inner channel 249 (e.g., back inner channel 249) is formed between the second conductive body and the second face of the inner body 312.

The fluid conduits 261, 263, 265 of the shaft include a first inlet conduit 261, a second inlet conduit 265, and an outlet conduit 263. The first inlet conduit 261 extends into the shaft from the first fluid inlet 201, the second inlet conduit 265 extends into the shaft from the second fluid inlet 205, and the outlet conduit 263 extends into the shaft from the fluid outlet 203. The outlet conduit 263 is disposed between the inlet conduits 261, 265, which are disposed 180 degrees away from each other.

The first ingress conduit 240 is fluidly coupled with and extends between the first inlet conduit 261 and the first inner channel 244. The second ingress conduit 241 is fluidly coupled with and extends between the first inlet conduit 261 and the second inner channel 249. The third ingress conduit 242 is fluidly coupled with and extends between the second inlet conduit 265 and the first inner channel 244. The fourth ingress conduit 243 is fluidly coupled with and extends between the second inlet conduit 265 and the second inner channel 249. The first and third ingress conduits 240, 242 are axially spaced from the second and fourth ingress conduits 241, 243 by the magnetic body.

The first egress conduit 245 is fluidly coupled with and extends between the outlet conduit 263 and the first inner channel 244. The second egress conduit 246 is fluidly coupled with and extends between the outlet conduit 263 and the second inner channel 249. The third egress conduit 247 is fluidly coupled with and extends between the outlet conduit 263 and the first inner channel 244. The fourth egress conduit 248 is fluidly coupled with and extends between the outlet conduit 263 and the second inner channel 249. The first and third egress conduits 245, 247 are axially spaced from the second and fourth egress conduits 246, 248 by the magnetic body.

The inner cavity 207 is formed between the conductive bodies 202, 204 and the magnetic body 200. For example, the first and third ingress conduits 240, 242, the first and third egress conduits 245, 247, and the first inner channel 244 are formed between the first face of the magnetic body and the inner face of the first conductive body. Similarly, the second and fourth ingress conduits 241, 243, the second and fourth egress conduits 246, 248, and the second inner channel 249 are formed between the second face of the magnetic body and the inner face of the second conductive body. The radial conduits 250 are radially bounded by and defined between the two conductive bodies, and circumferentially bounded between two adjacent liners of the magnetic body. The outer channels is defined between the two conductive bodies.

The fluid inlets 201, 205 and the fluid outlet 203 are fluidly coupled with an example pump 233. In some aspects, the pump 233 is controlled by the controller 118 (shown in FIG. 3) or a different controller. The fluid pump 233 flows the cooling fluid “F” into the fluid inlets 201, 205 and flows (or receives) the cooling fluid “F” out of the rotor 108 through the fluid outlet 203. The pump 233 can be coupled with the shaft 103 through a rotational fluid coupling.

The cooling fluid “F” can be a liquid. In some implementations, the cooling fluid “F” is an oil or another type of cooling fluid such as a coolant or refrigerant. The cooling fluid can also be a thermally conductive fluid and/or an electrically non-conductive (dielectric) coolant. In some aspects, the cooling fluid “F” can withstand high temperatures and is not magnetic. In some implementations, the pump 233 is a variable speed pump controlled by the control system 118 or a different controller to efficiently cool the stators of the induction machine 100. For example, the controller can vary the flow rate of the pump as a function of one or more parameters of the machine 100, such as temperature of the rotor 108, rotational speed of the rotor 108, etc. In some aspects, the pump can suck the fluid out of the rotor 108 through the fluid outlet 203 of the shaft to allow the fluid to exit the rotor despite the rotor's high rotational speeds and centrifugal forces. Moreover, the centrifugal force of the rotor 108 can distribute the cooling fluid “F” along most or all of the inner cavity.

The variable-speed pump 233 can help meet the hotspot temperature requirements of the rotor 108. For example, the electromagnetic losses (and consequently the generated heat) can vary at different motor speeds. For example, high losses occur at 5000 rpm, while there are lower losses at 20,000 rpm. Therefore, different coolant flow rates are required to meet the hotspot temperature requirements, which can be achieved by using the variable speed pump 233. In some aspects, the pump is controlled as a function of sensor feedback gathered by sensors 235 that are either at the rotor, shaft, or pump. Such sensors 235 are connected to a controller that controls the pump 233. Such sensors 235 can sense, for example, a pressure of the cooling fluid or inner cavity, a temperature of the cooling fluid or rotor, a flow rate of the cooling fluid, a rotational speed of the rotor, etc.

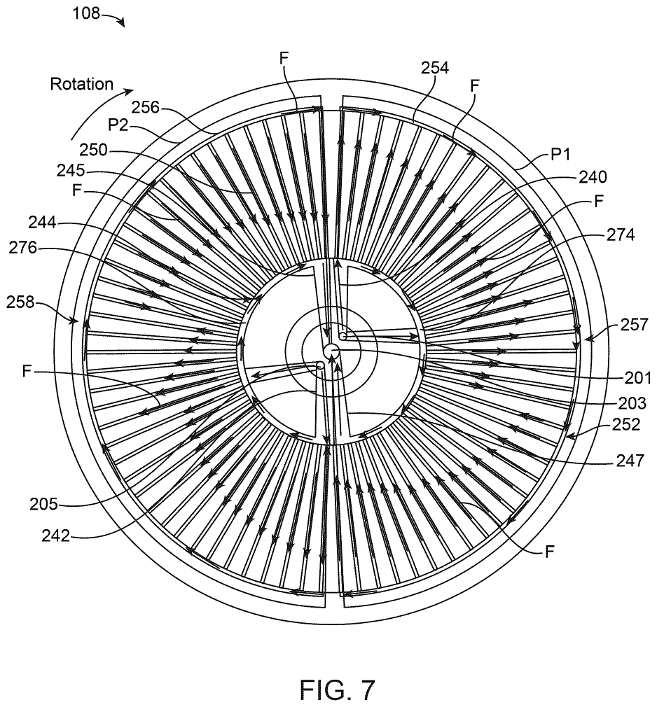

Referring also to FIG. 7, each inner channel (only the first inner channel 244 shown in FIG. 7) includes a first channel portion 274 and a second channel portion 276. Each channel portion 274, 276 spans about half a circumference of the inner channel 244 such that, together, they span substantially all of the circumference of the rotor. Similarly, the outer channel 252 has a first outer channel portion 254 and a second outer channel portion 256 that each span about half the circumference of the rotor. The inner channel portions 274, 276 are decoupled from each other (except for their common connection to the fluid outlet 203), and the outer channel portions 254, 256 are also decoupled from each other (except for their common connection to the fluid outlet 203).

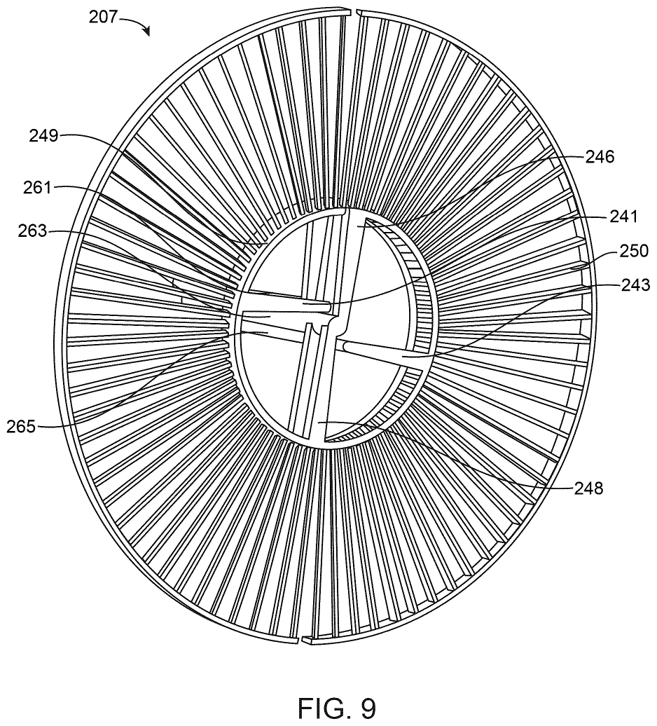

The first channel portion 274 is fluidly coupled with the first fluid inlet 201 of the shaft and the second channel portion 276 is fluidly coupled with the second fluid inlet 205 of the shaft. The first and second channel portions 274, 276 are fluidly coupled with the fluid outlet 203 of the shaft. Thus, the first channel portion 274 is fluidly coupled with the first ingress conduit 240, the third egress conduit 247, the first fluid inlet 201, and the fluid outlet 203. Similarly, the second channel portion 276 is fluidly coupled with the third ingress conduit 242, the first egress conduit 245, the second fluid inlet 205, and the fluid outlet 203. As further shown in detail below with respect to FIG. 9, the second inner channel 249 is fluidly connected to the second ingress conduit 241, fourth ingress conduit 243, second egress conduit 246, and fourth egress conduit 248 in a similar way.

The internal fluid conduits 250 include a first group 257 of internal fluid conduits and a second group 258 of internal fluid conduits. The first group 257 of internal fluid conduits is fluidly decoupled from the second group 258 of internal fluid conduits such that the fluid that enters the first group 257 of internal fluid conduits through the first ingress conduit 240 exits the rotor through the third egress conduit 247 (and does not exit through the first egress conduit 245).

The rotor 108 defines cooling fluid pathways “P1,” “P2” through which the cooling fluid “F” flows to cool the rotor 108. The cooling fluid pathways “P1,” “P2” include a first cooling fluid pathway “P1” and a second cooling fluid pathway “P2” that together span all or part of the circumference of the rotor 108. The first cooling fluid pathway “P1” extends from the first fluid inlet 201 to the first channel portion 274, from the first channel portion 274 through the first group 257 of internal fluid conduits to the outer channel 252 (e.g., the first outer channel portion 254), and from the outer channel 252 to the fluid outlet 203 via the first group 257 of conduits and the first channel portion 274.

The second cooling fluid pathway “P2” extends from the second fluid inlet 205 to the second channel portion 276, from the second channel portion 276 through the second group 258 of fluid conduits to the outer channel 252 (e.g., the second outer channel portion 256), and from the outer channel 252 to the fluid outlet 203 via the second group 258 of conduits and the second channel portion 276.

The first group 257 of radial conduits are all connected to the first inner channel portion 274 and the first outer channel portion 254, and the second group 258 of radial conduits are all connected to the second inner channel portion 276 and the second outer channel portion 256. FIG. 7 shows a highly schematic view of the direction of the cooling fluid “F” along the radial conduits 250 as the cooling fluid “F” flows toward and away from the outer channel 252. In some aspects, the flow within the channels and conduits is more chaotic than shown in FIG. 7. For example, the outward flow velocity magnitude (through the slots) gradually decreases, and after a certain point, the direction reverses (becoming inward). In the transition area, where the flow changes from going toward the outer channel 252 to going back to the inner channel 244, the flow in one or two radial conduits 250 can become relatively stationary, while the flow direction at both the inner and outer radii remains unchanged.

For example, with respect to the right half of the inner cavity, the cooling fluid “F” enters the inner cavity through the first ingress conduit 240. The combined effects of fluid pressure from the pump and centrifugal force due to rotation drive the cooling fluid “F” through the radial conduits 250, directing the cooling fluid “F” toward the outer channel portion 254. As the first few radial conduits 250 fill, some portion of the cooling fluid “F” also begins flowing through the inner channel portion 274. Once inside the inner cavity, the cooling fluid “F” primarily follows the rotation of the rotor. However, in some cases, the mass flow rate through each slot is not uniform. For example, the first radial conduit 250 experiences the strongest flow (represented by the longest flow vector), with each subsequent slot receiving progressively less cooling fluid “F.” This trend continues until the cooling fluid “F” from the second ingress conduit 241 merges with the existing flow, reinforcing the weakened cooling fluid distribution across certain radial conduits 250. At a critical point, as the cooling fluid “F” approaches the third egress conduit 247, the pressure difference induced by the pump causes the flow vectors through the radial conduits 250 to reverse direction. Eventually, the cooling fluid “F” exits the rotor through the third egress conduit 247 and returns to the shaft. A similar oil flow distribution occurs in the left half of the inner cavity.

The configuration of the shaft and embedded cavity of the rotor 108 allows the fluid to flow evenly through the cavity, reaching all or most of the corners and channels of the cavity and flowing highly uniformly throughout, which helps achieve a more uniform temperature distribution over the rotor body. Such configuration can help improve the cooling of the rotor and the overall performance of the rotor and the axial flux induction machine.

As shown in FIG. 9, the embedded cavity 207 includes the back inner channel 249, which receives fluid from the two ingress conduits 241, 243 that are dispersed at the back of the cavity 207. The two ingress conduits 241, 243 are connected to the two inlet conduits 261, 265 of the shaft. Moreover, the egress conduits 246, 248 receive the hot oil from the radial conduits 250 and direct the fluid out of the rotor to the outlet conduit 263 of the shaft. Similar to the front inner channel 241, the back inner channel 249 is not continuous, but spans all or most of the circumference of the rotor.

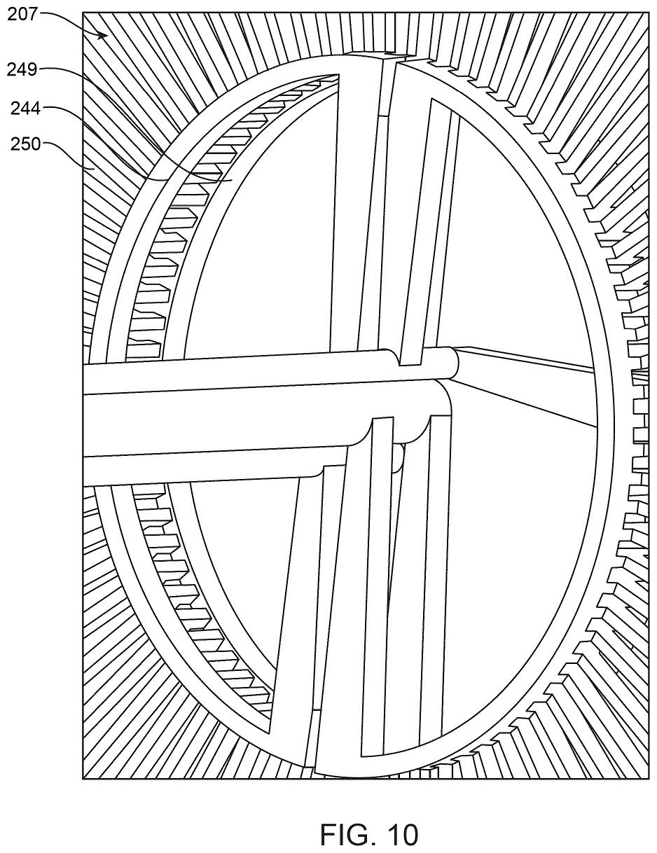

FIG. 10 shows a detail view of two inner channels 244, 249 of the inner cavity 207. As shown, the radial conduits 250 are fed fluid from the front and back inner channels 244, 249. In other words, the radial conduits 250 extend from the front and back inner channels 244, 249 to a common outer channel that is formed at the outer diameter of the rotor.

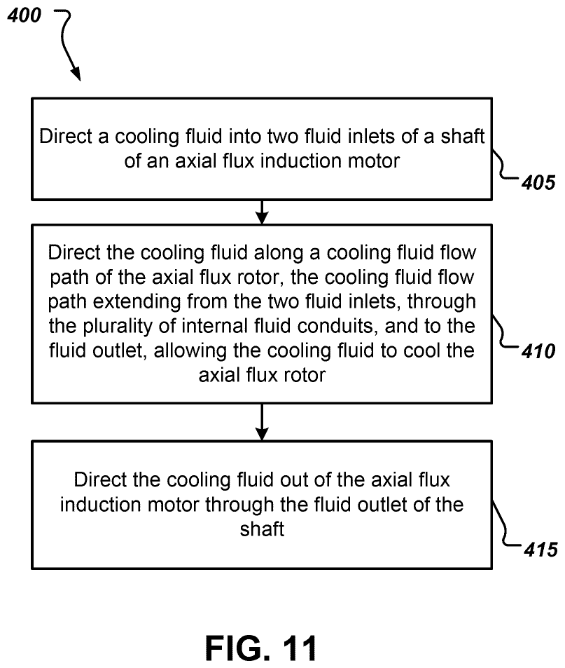

FIG. 11 is a flow chart of an example of a method 400 of cooling an axial flux rotor (e.g., the rotor 108 shown in FIG. 4). The method 400 includes directing a cooling fluid into two fluid inlets of a shaft of an axial flux induction motor (405). The axial flux induction motor includes a housing, a stator, and a rotor attached to the shaft. The shaft is rotatably coupled with the housing such that the rotor and shaft rotate together with respect to the stator and the housing. The shaft includes the two fluid inlets and a fluid outlet. The axial flux rotor includes an inner cavity fluidly coupled with the two fluid inlets and fluid outlet of the shaft. The inner cavity includes multiple internal fluid conduits extending radially with respect to the shaft. The method also includes directing the cooling fluid along a cooling fluid flow path of the axial flux rotor. (410). The cooling fluid flow path extends from the two fluid inlets, through the multiple internal fluid conduits, and to the fluid outlet, allowing the cooling fluid to cool the axial flux rotor. The method also includes directing the cooling fluid out of the axial flux induction motor through the fluid outlet of the shaft (415).

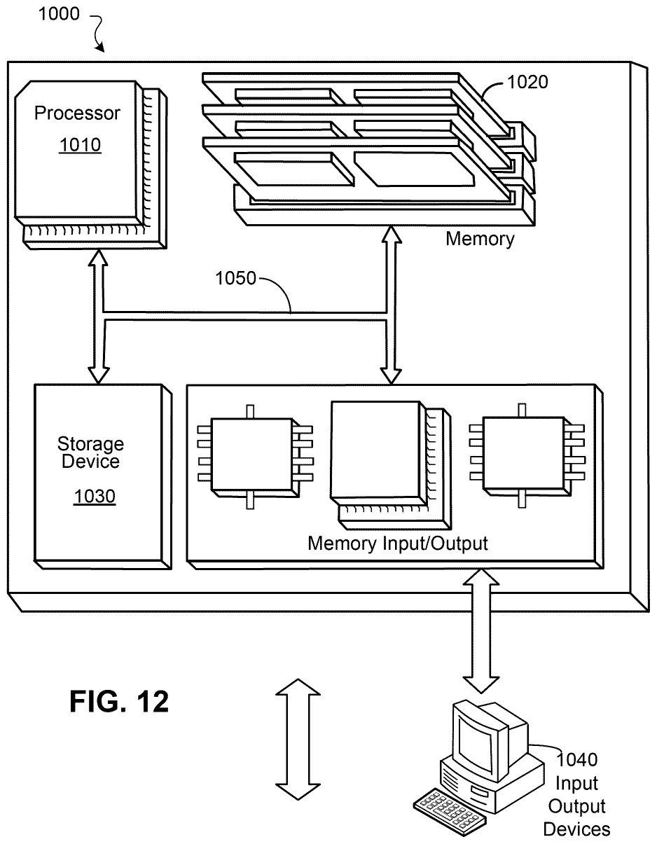

FIG. 12 is a schematic illustration of an example control system or controller for an axial flux induction machine according to the present disclosure. For example, the controller 1000 may include or be part of the controller 118 shown in FIG. 3. The controller 1000 is intended to include various forms of digital computers, such as printed circuit boards (PCB), processors, digital circuitry, or otherwise. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 1000 includes a processor 1010, a memory 1020, a storage device 1030, and an input/output device 1040. Each of the components 1010, 1020, 1030, and 1040 are interconnected using a system bus 1050. The processor 1010 is capable of processing instructions for execution within the controller 1000. The processor may be designed using any of a number of architectures. For example, the processor 1010 may be a CISC (Complex Instruction Set Computers) processor, a RISC (Reduced Instruction Set Computer) processor, or a MISC (Mini-mal Instruction Set Computer) processor.

In one implementation, the processor 1010 is a single-threaded processor. In another implementation, the processor 1010 is a multi-threaded processor. The processor 1010 is capable of processing instructions stored in the memory 1020 or on the storage device 1030 to display graphical information for a user interface on the input/output device 1040.

The memory 1020 stores information within the controller 1000. In one implementation, the memory 1020 is a computer-readable medium. In one implementation, the memory 1020 is a volatile memory unit. In another implementation, the memory 1020 is a non-volatile memory unit.

The storage device 1030 is capable of providing mass storage for the controller 1000. In one implementation, the storage device 1030 is a computer-readable medium. In various different implementations, the storage device 1030 may be a floppy disk device, a hard disk device, an optical disk device, or a tape device.

The input/output device 1040 provides input/output operations for the controller 1000. In one implementation, the input/output device 1040 includes a keyboard and/or pointing device. In another implementation, the input/output device 1040 includes a display unit for displaying graphical user interfaces.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, al-though features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

### EXAMPLES

In an example implementation, an axial flux rotor assembly includes a shaft and an axial flux rotor. The shaft is disposed within and rotatably coupled with a housing of an axial flux induction machine. The shaft includes a first fluid inlet, a second fluid inlet, and a fluid outlet. The first and second fluid inlets are fluidly coupled with and configured to receive a cooling fluid from a pump. The axial flux rotor is attached with and rotates with the shaft. The axial flux rotor includes an inner cavity fluidly coupled with and configured to receive the cooling fluid from the first and second fluid inlets of the shaft. The inner cavity includes an inner channel, an outer channel, and multiple internal fluid conduits. The inner channel includes a first channel portion fluidly coupled with the first fluid inlet and a second channel portion fluidly coupled with the second fluid inlet. The first and second channel portions are fluidly coupled with the fluid outlet of the shaft. The internal fluid conduits extend radially between and are fluidly coupled with the inner channel and the outer channel. The internal fluid conduits include first internal fluid conduits and second internal fluid conduits. The axial flux rotor defines cooling fluid pathways to allow a cooling fluid to cool the axial flux rotor. The cooling fluid pathways include a first cooling fluid pathway and a second cooling fluid pathway. The first cooling fluid pathway extends from the first fluid inlet to the first channel portion, from the first channel portion through the first internal fluid conduits to the outer channel, and from the outer channel to the fluid outlet via the first channel portion. The second cooling fluid pathway extends from the second fluid inlet to the second channel portion, from the second channel portion through the second internal fluid conduits to the outer channel, and from the outer channel to the fluid outlet via the second channel portion.

In an example implementation combinable with any other example implementation, the rotor includes a first conductive body, a second conductive body, and a magnetic body disposed between the first conductive body and the second conductive body. The first and second conductive bodies include multiple of radial bars interlocked with radial liners of the magnetic body to allow an axial magnetic field from a stator of the axial flux induction motor to extend through and rotate the rotor.

In an example implementation combinable with any other example implementation, the rotor includes a first conductive body, a second conductive body, and a magnetic body. The first conductive body includes a first inner ring, a first outer ring, and a first group of bars spaced by first gaps and extending radially between and attached to the first inner ring and first outer ring. The second conductive body includes a second inner ring, a second outer ring, and a second group of bars spaced by second gaps and extending radially between and attached to the second inner ring and second outer ring. The magnetic body is attached to the shaft and is disposed between and interlocked with the first conductive body and the second conductive body. The magnetic body includes an inner body and multiple radial liners extending from the inner body. Each is disposed within the first and second gaps to form, with the first and second conductive bodies, the multiple internal fluid conduits enclose axially between the first and second group of bars.

In an example implementation combinable with any other example implementation, the first conductive body defines, with a first face of the inner body of the magnetic body, a first ingress conduit and a second ingress conduit, and the second conductive body defines, with a second face of the inner body opposite the first face, a third ingress conduit and a fourth ingress conduit. The first and second ingress conduits extend between and are fluidly coupled with the shaft and the inner channel, and the third and fourth ingress conduits extend between and are fluidly coupled with the shaft and the inner channel.

In an example implementation combinable with any other example implementation, the first ingress conduit is fluidly coupled with the first inlet of the shaft and the second ingress conduit is fluidly coupled with the second fluid inlet of the shaft. The third ingress conduit is fluidly coupled with the first inlet of the shaft and the fourth ingress conduit is fluidly coupled with the second fluid inlet of the shaft. In an example implementation combinable with any other example implementation, the inner channel includes a first inner annular channel and the axial flux rotor assembly further includes a second inner annular channel. The first inner annular channel is formed between the first conductive body and the first face of the inner body, The second inner annular channel is formed between the second conductive body and the second face of the inner body.

In an example implementation combinable with any other example implementation, the first conductive body defines, with the first face of the inner body of the magnetic body, a first egress conduit and second egress conduit. The first and second egress conduits are fluidly coupled with and extending between the fluid outlet of the shaft and the first inner annular channel. The second conductive body defines, with the second face of the inner body of the magnetic body, a third egress conduit and a fourth egress conduit. The third and fourth egress conduits fluidly area coupled with and extend between the fluid outlet of the shaft and the second inner annular channel.

In an example implementation combinable with any other example implementation, the second inner annular channel includes a third channel portion and a fourth channel portion. The first ingress conduit extends between and is fluidly coupled with the first fluid inlet of the shaft and the first channel portion. The second ingress conduit extends between and is fluidly coupled with the second fluid inlet of the shaft and the second channel portion. The third ingress conduit extends between and is fluidly coupled with the first fluid inlet of the shaft and the third channel portion, and the fourth ingress conduit extends between and is fluidly coupled with the second fluid inlet of the shaft and the fourth channel portion. In an example implementation combinable with any other example implementation, the first channel portion spans half a circumference of the first inner annular channel. The second portion spans the other half of the circumference of the first inner annular channel. The third channel portion spans half a circumference of the second inner annular channel, and the fourth channel portion spans the other half of the circumference of the second inner annular channel.

In an example implementation combinable with any other example implementation, the magnetic body is made of a ferromagnetic material and the first and second conductive bodies are made of a diamagnetic material. In an example implementation combinable with any other example implementation, the magnetic body forms, with the first conductive body, a first side surface that faces an axial flux stator of the axial flux induction machine, and the magnetic body forms, with the second conductive body, a second side surface oppose and facing away from the first side surface. The first side surface and second side surface are electroplated to fluidly isolate the multiple fluid conduits from the axial flux stator. In an example implementation combinable with any other example implementation, the first conductive body includes a first coupling inner body and the second conductive body includes a second coupling inner body. The first and second coupling inner bodies are attached to and sandwich the inner body of the magnetic body to attach the magnetic body to the first and second conductive bodies.

In an example implementation combinable with any other example implementation, the shaft and axial flux rotor rotate together with respect to one or more axial flux stators disposed within the housing. In an example implementation combinable with any other example implementation, the pump flows the cooling fluid into the first and second fluid inlets of the shaft and flows the cooling fluid out of the multiple fluid conduits through the fluid outlet of the shaft.

In another example implementation, an axial flux rotor assembly includes a shaft and an axial flux rotor. The shaft is disposed within and rotatably coupled with a housing of an axial flux induction machine. The shaft includes at least one fluid inlet and a fluid outlet. The at least one fluid inlet receives a cooling fluid to cool the shaft. The axial flux rotor is attached with and rotates with the shaft. The axial flux rotor includes an inner cavity fluidly coupled with and arranged to receive the cooling fluid from the at least one fluid inlet of the shaft. The inner cavity includes multiple internal fluid conduits extending radially with respect to the shaft. The axial flux rotor defines a cooling fluid pathway extending from the at least one fluid inlet of the shaft to a first section of the multiple internal fluid conduits, from the first section of the multiple internal fluid conduits to a second section of the multiple internal fluid conduits, and from the second section of the multiple internal fluid conduits to the fluid outlet of the shaft to allow the cooling fluid to cool, as the cooling fluid flows along the cooling fluid pathway, the axial flux rotor.

In an example implementation combinable with any other example implementation, the at least one fluid inlet of the shaft includes a first fluid inlet, second fluid inlet. The axial flux rotor further includes an inner channel and an outer channel. The inner channel includes a first channel portion fluidly coupled with the first fluid inlet of the shaft and a second channel portion fluidly coupled with the second fluid inlet of the shaft. The first and second channel portions are fluidly coupled with the fluid outlet of the shaft. The multiple internal fluid conduits extend radially between and are fluidly coupled with the inner channel and the outer annular channel. The cooling fluid pathway including a first cooling fluid pathway and the axial flux rotor assembly includes a second cooling fluid pathway. The first cooling fluid pathway extends from the first fluid inlet to the first channel portion, from the first channel portion through a first section of the multiple internal fluid conduits to the outer channel and back to the first channel portion, and from the first channel portion to the fluid outlet. The second cooling fluid pathway extends from the second fluid inlet to the second channel portion, from the second channel portion through a second section of the multiple internal fluid conduits to the outer channel and back to the second channel portion, and from the second channel portion to the fluid outlet to allow the cooling fluid to cool, as the cooling fluid flows along the first and second cooling fluid pathways, the axial flux rotor.

In an example implementation combinable with any other example implementation, the rotor includes an inner body including a pilot notch arranged to receive and engage with a rib of the shaft to align, during assembly of the rotor with the shaft, ingress conduits and egress conduits of the rotor with the fluid inlet and fluid outlet of the shaft. The ingress conduits and egress conduits are fluidly coupled with and extending between the shaft and the multiple fluid conduits of the rotor.

In an example implementation combinable with any other example implementation, the axial flux rotor assembly also includes a fluid pump coupled with the shaft and arranged to flow the cooling fluid into the first and second fluid inlets of the shaft and flow the cooling fluid out of the multiple fluid conduits through the fluid outlet of the shaft. In an example implementation combinable with any other example implementation, the pump is a variable speed pump configured to change a flow rate of the cooling fluid as a function of a speed of the axial flux rotor. In an example implementation combinable with any other example implementation, the shaft and axial flux rotor are arranged to rotate together with respect to one or more axial flux stators disposed within the housing. In an example implementation combinable with any other example implementation, the cooling fluid is a thermally conductive, electrically non-conductive (dielectric) coolant.

In another example implementation, a method of cooling an axial flux rotor includes directing a cooling fluid into two fluid inlets of a shaft of an axial flux induction motor. The axial flux induction motor includes a housing, a stator, and a rotor attached to the shaft. The shaft is rotatably coupled with the housing such that the rotor and shaft rotate together with respect to the stator and the housing. The shaft includes the two fluid inlets and a fluid outlet. The axial flux rotor includes an inner cavity fluidly coupled with the two fluid inlets and fluid outlet of the shaft. The inner cavity includes multiple internal fluid conduits extending radially with respect to the shaft. The method also includes directing the cooling fluid along a cooling fluid flow path of the axial flux rotor. The cooling fluid flow path extends from the two fluid inlets, through the multiple internal fluid conduits, and to the fluid outlet, allowing the cooling fluid to cool the axial flux rotor. The method also include directing the cooling fluid out of the axial flux induction motor through the fluid outlet of the shaft.

In an example implementation combinable with any other example implementation, directing the cooling fluid into the two fluid inlets includes directing, with a variable speed pump controlled as a function of sensor feedback, the flow of the cooling fluid, the sensor feedback including at least one of a rotational speed of the rotor or a temperature of the rotor.

What is claimed is:

1. An axial flux rotor assembly, comprising:
a shaft configured to be disposed within and rotatably coupled with a housing of an axial flux induction machine, the shaft comprising a first fluid inlet, a second fluid inlet, and a fluid outlet, the first and second fluid inlets fluidly coupled with and configured to receive a cooling fluid from a pump; and
an axial flux rotor coupled with and configured to rotate with the shaft, the axial flux rotor comprising an inner cavity fluidly coupled with and configured to receive the cooling fluid from the first and second fluid inlets of the shaft, the inner cavity comprising:
an inner channel comprising a first channel portion fluidly coupled with the first fluid inlet and a second channel portion fluidly coupled with the second fluid inlet, the first and second channel portions fluidly coupled with the fluid outlet of the shaft,
an outer channel, and
a plurality of internal fluid conduits extending radially between and fluidly coupled with the inner channel and the outer channel, the plurality of internal fluid conduits comprising first internal fluid conduits and second internal fluid conduits,
wherein the axial flux rotor defines cooling fluid pathways to allow a cooling fluid to cool the axial flux rotor, the cooling fluid pathways comprising a first cooling fluid pathway and a second cooling fluid pathway,
wherein the first cooling fluid pathway extends from the first fluid inlet to the first channel portion, from the first channel portion through the first internal fluid conduits to the outer channel, and from the outer channel to the fluid outlet via the first channel portion, and
wherein the second cooling fluid pathway extends from the second fluid inlet to the second channel portion, from the second channel portion through the second internal fluid conduits to the outer channel, and from the outer channel to the fluid outlet via the second channel portion.

2. The axial flux rotor assembly of claim 1, wherein the axial flux rotor comprises a first conductive body, a second conductive body, and a magnetic body disposed between the first conductive body and the second conductive body, the first and second conductive bodies comprising a plurality of radial bars interlocked with radial liners of the magnetic body to allow an axial magnetic field from a stator of the axial flux induction machine to extend through and rotate the axial flux rotor.

3. The axial flux rotor assembly of claim 1, wherein the axial flux rotor comprises:
a first conductive body comprising a first inner ring, a first outer ring, and a first plurality of bars spaced by first gaps and extending radially between and coupled with the first inner ring and first outer ring;
a second conductive body comprising a second inner ring, a second outer ring, and a second plurality of bars spaced by second gaps and extending radially between and coupled with the second inner ring and second outer ring; and
a magnetic body coupled with the shaft and disposed between and interlocked with the first conductive body and the second conductive body, the magnetic body comprising an inner body and a plurality of radial liners extending from the inner body and each disposed within the first and second gaps to form, with the first and second conductive bodies, the plurality of internal fluid conduits enclosed axially between the first and second plurality of bars.

4. The axial flux rotor assembly of claim 3, wherein the first conductive body defines, with a first face of the inner body of the magnetic body, a first ingress conduit and a second ingress conduit, and the second conductive body defines, with a second face of the inner body opposite the first face, a third ingress conduit and a fourth ingress conduit, wherein the first and second ingress conduits extend between and are fluidly coupled with the shaft and the inner channel, and wherein the third and fourth ingress conduits extend between and are fluidly coupled with the shaft and the inner channel.

5. The axial flux rotor assembly of claim 4, wherein the first ingress conduit is fluidly coupled with the first fluid inlet of the shaft and the second ingress conduit is fluidly coupled with the second fluid inlet of the shaft, and wherein the third ingress conduit is fluidly coupled with the first fluid inlet of the shaft and the fourth ingress conduit is fluidly coupled with the second fluid inlet of the shaft.

6. The axial flux rotor assembly of claim 4, wherein the inner channel comprises a first inner annular channel and the axial flux rotor assembly further comprises a second inner annular channel, the first inner annular channel formed between the first conductive body and the first face of the inner body, and the second inner annular channel formed between the second conductive body and the second face of the inner body.

7. The axial flux rotor assembly of claim 6, wherein the first conductive body defines, with the first face of the inner body of the magnetic body, a first egress conduit and second egress conduit, the first and second egress conduits fluidly coupled with and extending between the fluid outlet of the shaft and the first inner annular channel, and the second conductive body defines, with the second face of the inner body of the magnetic body, a third egress conduit and a fourth egress conduit, the third and fourth egress conduits fluidly coupled with and extending between the fluid outlet of the shaft and the second inner annular channel.

8. The axial flux rotor assembly of claim 6, wherein the second inner annular channel comprises a third channel portion and a fourth channel portion, the first ingress conduit extending between and fluidly coupled with the first fluid inlet of the shaft and the first channel portion, the second ingress conduit extending between and fluidly coupled with the second fluid inlet of the shaft and the second channel portion, the third ingress conduit extending between and fluidly coupled with the first fluid inlet of the shaft and the third channel portion, and the fourth ingress conduit extending between and fluidly coupled with the second fluid inlet of the shaft and the fourth channel portion.

9. The axial flux rotor assembly of claim 8, wherein the first channel portion spans a first half a circumference of the first inner annular channel, the second channel portion spans a second half of the circumference of the first inner annular channel, the third channel portion spans a first half of a circumference of the second inner annular channel, and the fourth channel portion spans a second half of the circumference of the second inner annular channel.

10. The axial flux rotor assembly of claim 3, wherein the magnetic body is made of a ferromagnetic material and the first and second conductive bodies are made of a diamagnetic material.

11. The axial flux rotor assembly of claim 3, wherein the magnetic body forms, with the first conductive body, a first side surface that faces an axial flux stator of the axial flux induction machine, and the magnetic body forms, with the second conductive body, a second side surface oppose and facing away from the first side surface, and the first side surface and second side surface are electroplated to fluidly isolate the plurality of internal fluid conduits from the axial flux stator.

12. The axial flux rotor assembly of claim 3, wherein the first conductive body comprises a first coupling inner body and the second conductive body comprises a second coupling inner body, the first and second coupling inner bodies coupled with and sandwiching the inner body of the magnetic body to attach the magnetic body to the first and second conductive bodies.

13. The axial flux rotor assembly of claim 1, wherein the shaft and axial flux rotor are arranged to rotate together with respect to one or more axial flux stators disposed within the housing.

14. The axial flux rotor assembly of claim 1, wherein the pump is configured to flow the cooling fluid into the first and second fluid inlets of the shaft and flow the cooling fluid out of the plurality of internal fluid conduits through the fluid outlet of the shaft.

15. An axial flux rotor assembly, comprising:
a shaft configured to be disposed within and rotatably coupled with a housing of an axial flux induction machine, the shaft comprising at least one fluid inlet and a fluid outlet, the at least one fluid inlet configured to receive a cooling fluid to cool the shaft; and
an axial flux rotor coupled with and configured to rotate with the shaft, the axial flux rotor comprising an inner cavity fluidly coupled with and configured to receive the cooling fluid from the at least one fluid inlet of the shaft, the inner cavity comprising a plurality of internal fluid conduits extending radially with respect to the shaft,
wherein the axial flux rotor defines a cooling fluid pathway extending from the at least one fluid inlet of the shaft to a first section of the plurality of internal fluid conduits, from the first section of the plurality of internal fluid conduits to a second section of the plurality of internal fluid conduits, and from the second section of the plurality of internal fluid conduits to the fluid outlet of the shaft to allow the cooling fluid to cool, as the cooling fluid flows along the cooling fluid pathway, the axial flux rotor.

16. The axial flux rotor assembly of claim 15, wherein the at least one fluid inlet of the shaft comprises a first fluid inlet and a second fluid inlet, the axial flux rotor further comprising:
an inner channel comprising a first channel portion fluidly coupled with the first fluid inlet of the shaft and a second channel portion fluidly coupled with the second fluid inlet of the shaft, the first and second channel portions fluidly coupled with the fluid outlet of the shaft, and
an outer channel, and
wherein the plurality of internal fluid conduits extend radially between and are fluidly coupled with the inner channel and the outer channel, the cooling fluid pathway comprising a first cooling fluid pathway and the axial flux rotor assembly comprises a second cooling fluid pathway, the first cooling fluid pathway extending from the first fluid inlet to the first channel portion, from the first channel portion through a first section of the plurality of internal fluid conduits to the outer channel and back to the first channel portion, and from the first channel portion to the fluid outlet, and the second cooling fluid pathway extends from the second fluid inlet to the second channel portion, from the second channel portion through a second section of the plurality of internal fluid conduits to the outer channel and back to the second channel portion, and from the second channel portion to the fluid outlet to allow the cooling fluid to cool, as the cooling fluid flows along the first and second cooling fluid pathways, the axial flux rotor.

17. The axial flux rotor assembly of claim 16, wherein the axial flux rotor comprises an inner body comprising a pilot notch arranged to receive and engage with a rib of the shaft to align, during assembly of the axial flux rotor with the shaft, ingress conduits and egress conduits of the axial flux rotor with the fluid inlet and fluid outlet of the shaft, the ingress conduits and egress conduits fluidly coupled with and extending between the shaft and the plurality of internal fluid conduits of the axial flux rotor.

18. The axial flux rotor assembly of claim 16, further comprising a fluid pump coupled with the shaft and configured to flow the cooling fluid into the first and second fluid inlets of the shaft and flow the cooling fluid out of the plurality of internal fluid conduits through the fluid outlet of the shaft.

19. The axial flux rotor assembly of claim 18, wherein the fluid pump comprising a variable speed pump configured to change a flow rate of the cooling fluid as a function of a speed of the axial flux rotor.

20. The axial flux rotor assembly of claim 15, wherein the shaft and axial flux rotor are arranged to rotate together with respect to one or more axial flux stators disposed within the housing.

21. A method of cooling an axial flux rotor, the method comprising:
directing a cooling fluid into two fluid inlets of a shaft of an axial flux induction motor, the axial flux induction motor comprising a housing, a stator, and a rotor coupled with the shaft, the shaft rotatably coupled with the housing such that the rotor and shaft rotate together with respect to the stator and the housing, the shaft comprising the two fluid inlets and a fluid outlet, the rotor comprising an inner cavity fluidly coupled with the two fluid inlets and fluid outlet of the shaft, the inner cavity comprising a plurality of internal fluid conduits extending radially with respect to the shaft;
directing the cooling fluid along a cooling fluid flow path of the rotor, the cooling fluid flow path extending from the two fluid inlets, through the plurality of internal fluid conduits, and to the fluid outlet, allowing the cooling fluid to cool the rotor; and
directing the cooling fluid out of the axial flux induction motor through the fluid outlet of the shaft.

22. The method of claim 21, wherein directing the cooling fluid into the two fluid inlets comprises directing, with a variable speed pump controlled as a function of sensor feedback, a flow of the cooling fluid, the sensor feedback comprising at least one of a rotational speed of the rotor or a temperature of the rotor.
